(19) United States
(12) Patent Application Publication
(10) Pub. No.: US 2019/0077325 A1
(43) Pub. Date: Mar. 14, 2019

(54) Vehicle identification window display

(71) Applicants: MYRIAM BOUKARI, ATLANTA, GA (US); LEONDRUS MCBRIDE, JR., Atlanta, GA (US)

(72) Inventors: MYRIAM BOUKARI, ATLANTA, GA (US); LEONDRUS MCBRIDE, JR., Atlanta, GA (US)

(21) Appl. No.: 16/128,216

(22) Filed: Sep. 11, 2018

Related U.S. Application Data
(60) Provisional application No. 62/557,135, filed on Sep. 11, 2017.

(51) Int. Cl. B60R 7/08

(52) U.S. Cl. CPC B60R 7/08; B60R 2011/004

(57) ABSTRACT

The present invention is a highly visible clear vehicle identification window device for displaying a vehicle registration, insurance card and driver license (or gun permit if applicable) and the like, that can be prominently displayed on the outside of a vehicle window glass pane and easily removed by an officer when conducting a routine traffic stop, the officer can then take this lightweight device with him/her and inspect the driver's credentials from the safety and confines of the patrol car.

### CROSS-REFERENCE TO RELATED APPLICATIONS

The present application relates and claims priority to U.S. provisional patent application No. 62/557,135 filed on Sep. 11, 2017.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to a vehicle identification window display, more particularly, relates to a highly visible clear device for displaying a vehicle registration, insurance card and driver license (or gun permit if applicable) and the like.

### Description of the Related Art

In the interest of fostering goodwill between motorist and members of law enforcement, and expediency during sometimes contentious traffic stops, it would be advantageous to provide a highly visible clear device for displaying a vehicle registration, insurance card and driver license (or gun permit if applicable) and the like, that can be prominently displayed on the outside of a vehicle window glass pane and easily removed by an officer when conducting a routine traffic stop. The officer can then take this lightweight device with him/her and inspect the driver's credentials from the safety and confines of the patrol car. A device suitable for this purpose has not been available in the art of the present disclosure, in the art there are some vehicle identification window displays as disclosed in the patent number US20150077327A1 but they are electronic displays, in light of this fact, the present disclosure has its unique future as it can not get technical failures.

The claimed vehicle window display embodiment is used for receiving and retaining a vehicle registration, and a plurality of rectangular cards, such as a driver license, insurance card, ID card, gun permit (if applicable) and the like, in transparent rectangular pockets or triangular slots for use by motorist when stopped by members of law enforcement during routine traffic stops, to simplify and deescalate the traffic stop process, and foster goodwill between members of law enforcement and motorist.

### BRIEF SUMMARY OF THE INVENTION

This invention concerns an improved highly visible device for displaying a vehicle registration, insurance card and driver license (or gun permit if applicable) and the like, that can be prominently displayed on the outside of a vehicle window glass pane and easily removed by an officer when conducting a routine traffic stop. The officer can then take this light weight device with him/her and inspect the driver's credentials from the safety and confines of the patrol car.

A vehicle identification window display according to one disclosed non-limiting embodiment of the present disclosure provide the ability to the officer to easily check a vehicle registration, insurance card and driver license (or gun permit if applicable) or any other related docs.

Another embodiment of the present disclosure is the interest of fostering goodwill between motorist and members of law enforcement, and expediency during sometimes contentious traffic stops.

Another embodiment of the present disclosure is to allow an easy and seamless traffic stop where all officers have to do is grab the device off the window and run the motorist information.

Another embodiment of the present disclosure where motorist can feel safe by just placing their identification/registration on the window for the officer.

These features and elements as well as the operation thereof will become more apparent in light of the following description and the accompanying drawings. It should be understood, however, the following description and drawings are intended to be exemplary in nature and non-limiting.

### DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a front perspective view of the first embodiment of a vehicle window display.

FIG. 2 is a partial side perspective view of the FIG. 1 embodiment.

FIG. 3 is a elevated side perspective view of the FIG. 1 embodiment.

FIG. 4 is a top elevated perspective view of the FIG. 1 embodiment.

FIG. 5 is a front perspective view of the FIG. 1 embodiment representing operative engagement with a vehicle registration, driver license and Insurance card which is depicted in broken lining.

FIG. 6 is a top elevated perspective view of the FIG. 1 embodiment mounted atop a partially open vehicle window pane glass with operative engagement with a vehicle registration, driver license and other rectangular card.

FIG. 7 is a side elevated perspective view of the FIG. 1 embodiment mounted atop a partially open vehicle window glass pane.

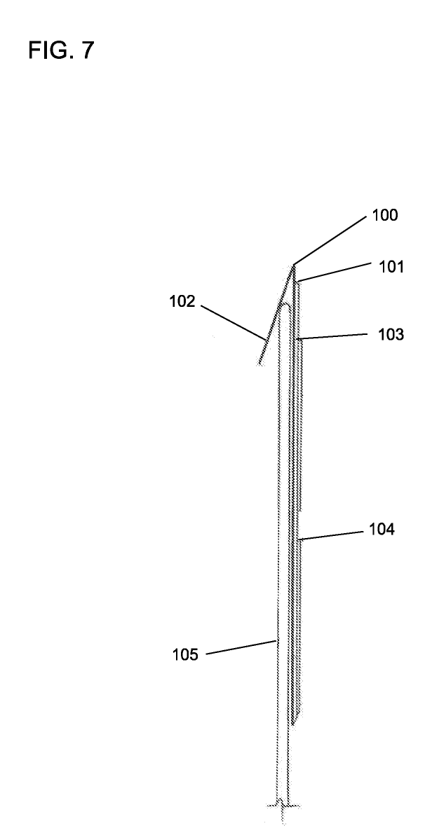

FIG. 8 is a rear perspective view of the FIG. 1 embodiment.

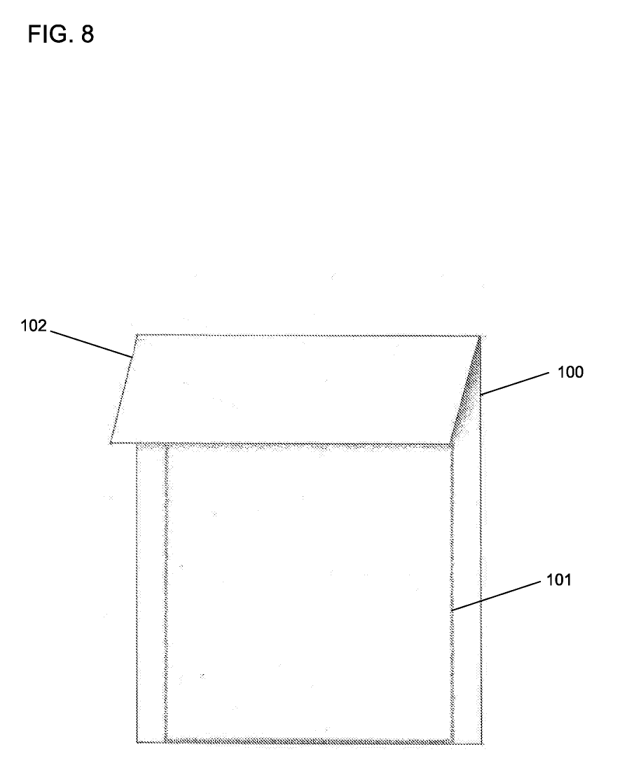

FIG. 9 is a front perspective view of a second embodiment of the VWD 100, as illustrated in FIG. 1, having flat triangular transparent slots for receiving and retaining a plurality of plastic cards, such as a driver license, insurance card, ID card, gun permit or the like.

FIG. 10 is a partial side perspective view of the FIG. 9 embodiment.

FIG. 11 is a elevated side perspective view of the FIG. 9 embodiment.

FIG. 12 is a front perspective view of the FIG. 9 embodiment, representing operative engagement with a vehicle registration, driver license and insurance card, which are depicted in partially broken lines.

FIG. 13 is a rear perspective view of the FIG. 9 embodiment.

FIG. 14 is a front perspective view of a third embodiment of the VWD 100, as illustrated in FIG. 1, having a flat rectangular transparent pocket for receiving and retaining a for sale sign or other form of advertisement.

FIG. 15 is a top elevated perspective view of the FIG. 14 embodiment.

FIG. 16 is a rear perspective view of the FIG. 14 embodiment.

### REFERENCE NUMERALS IN THE DRAWINGS

For a more complete understanding of the present invention parts, reference is now made to the following descriptions:
100—Frame
101—Inner pocket for vehicle registration
102—Flange
103—Pocket #1 for identification
104—Pocket #2 for Insurance card or gun permit
105—The car window glass
200—Frame
201—Inner pocket for vehicle registration
202—Rear flange
203—Corner slots #1 to hold identification
204—Corner slots #2 to hold Insurance card or gun permit
300—Frame
301—Display pocket for sign
302—Rear flange
303—Stitch or reflective ribbon

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

### Glossary of Terms

As used herein, VWD may refer to the vehicle window display.

The following section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The present disclosure is a new vehicle window display embodiment, as set forth in the following specification. The claimed vehicle window display embodiment is used for receiving and retaining a vehicle registration, and a plurality of rectangular cards, such as a driver license, insurance card, ID card, gun permit (if applicable) and the like, in transparent rectangular pockets or triangular slots for use by motorist when stopped by members of law enforcement during routine traffic stops, to simplify and deescalate the traffic stop process, and foster goodwill between members of law enforcement and motorist.

The vehicle window display is placed on the vehicle window to display identification to the officer where the material is a very durable transparent plastic with colorful reflective tape around the edges.

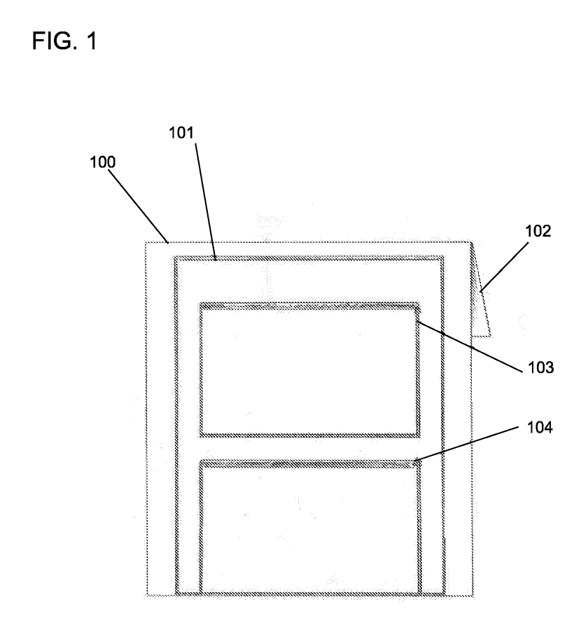

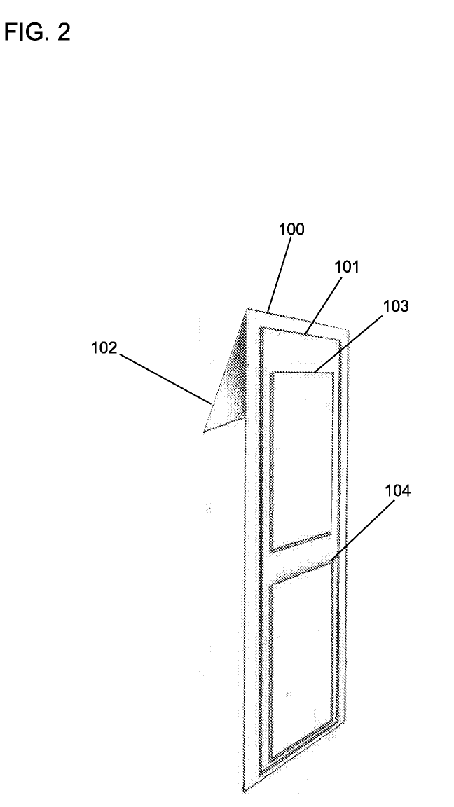

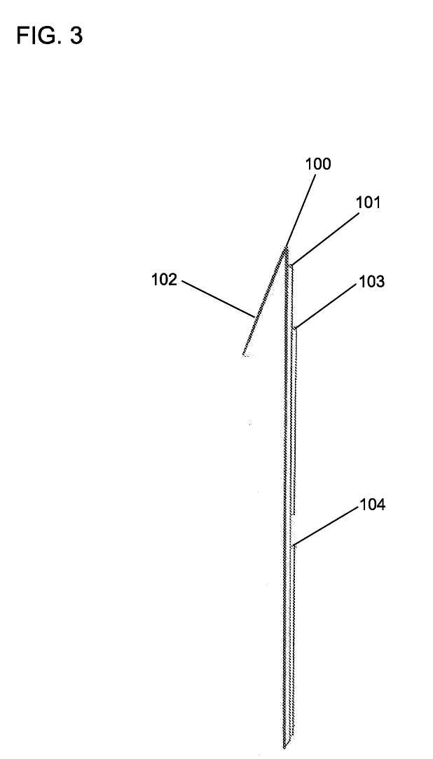

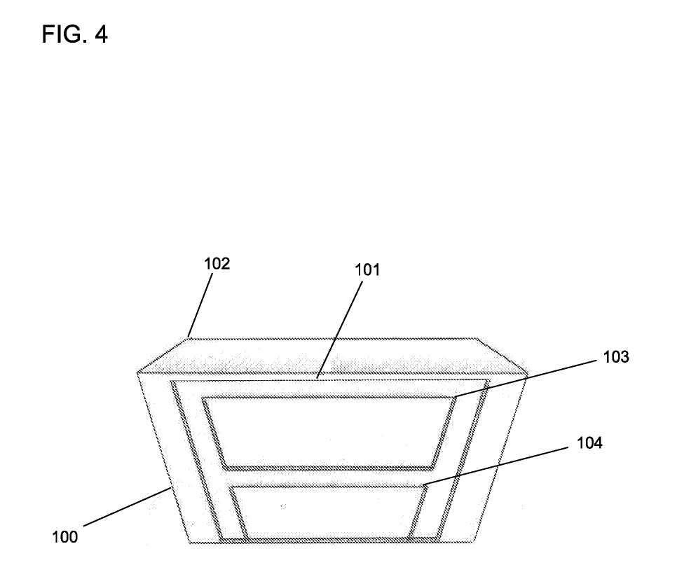

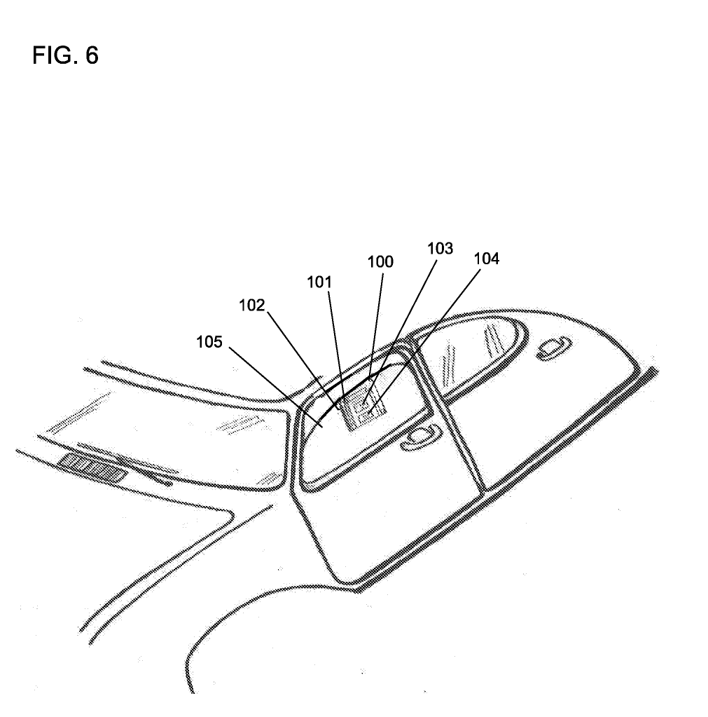

Referring to FIG. 1, this is a front perspective view of the first embodiment of a vehicle window display, referring to FIG. 2 this is a partial side perspective view of the FIG. 1 embodiment, referring to FIG. 3 this is a elevated side perspective view of the FIG. 1 embodiment, and referring to FIG. 4 this is a top elevated perspective view of the FIG. 1 embodiment. Referring to FIG. 1, FIG. 2, FIG. 3 and FIG. 4, these are the views of a first embodiment of a VWD, the VWD is depicted in its most basic configuration, in the depicted embodiment, the frame 100 consist of a flat transparent rectangular frame preferably made from a durable lightweight plastic or other man made material. The frame 100 includes a back reversive rectangular shaped flange 102 constructed to be easily affixed atop a partially open window glass pane for outside display, as illustrated in FIG. 6.

The vehicle registration holder 101 is constructed by placing a smaller lightweight transparent flattened rectangular plastic atop the frame 100 to create a pocket for receiving and retaining a vehicle registration as illustrated in FIG. 1. The vehicle registration holder 101 having a length and width with the length being larger than the width. The pockets of the vehicle registration holder is open along the width edges and closed along the length edges, as seen in FIG. 1 into which a vehicle registration is inserted for easy display.

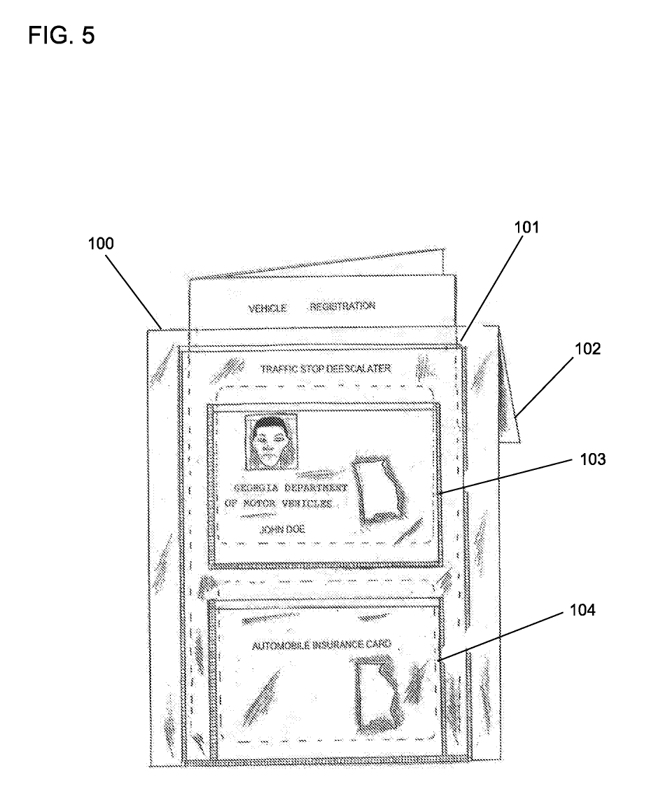

The pocket 1 for identification 103 and the pocket 2 for Insurance card or gun permit consist of transparent plastic or other man made material having a shaping element that has a width and length that are approximately identical to a width and length of the rectangular cards being held, as illustrated in FIG. 5 into which the cards are inserted for easy display. The rectangular card holders are attached to the front of the vehicle registration holder to form the pocket 1 for identification 103 and pocket 2 for Insurance card or gun permit 104 for receiving and retaining a plurality of plastic cards. The pocket 1 for identification 103 and pocket 2 for Insurance card or gun permit 104 are open along the width edges and closed along the length edges.

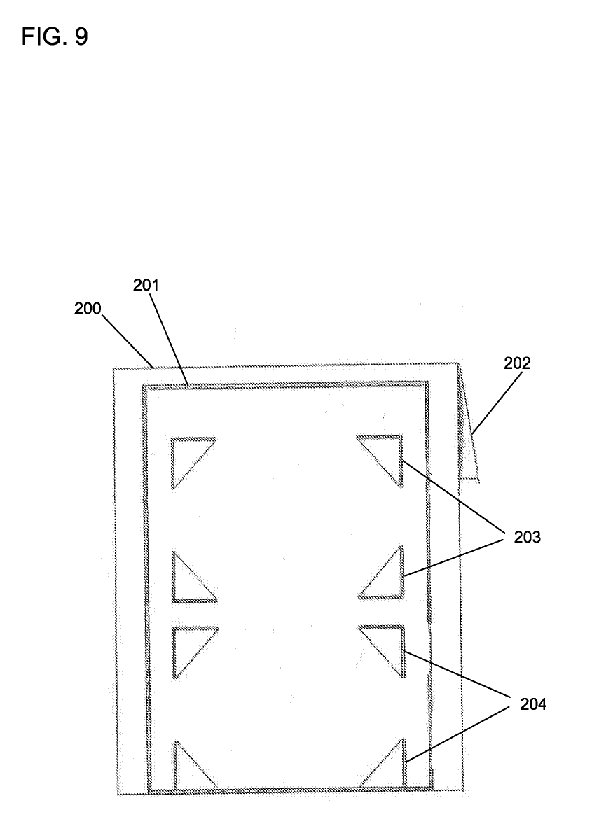

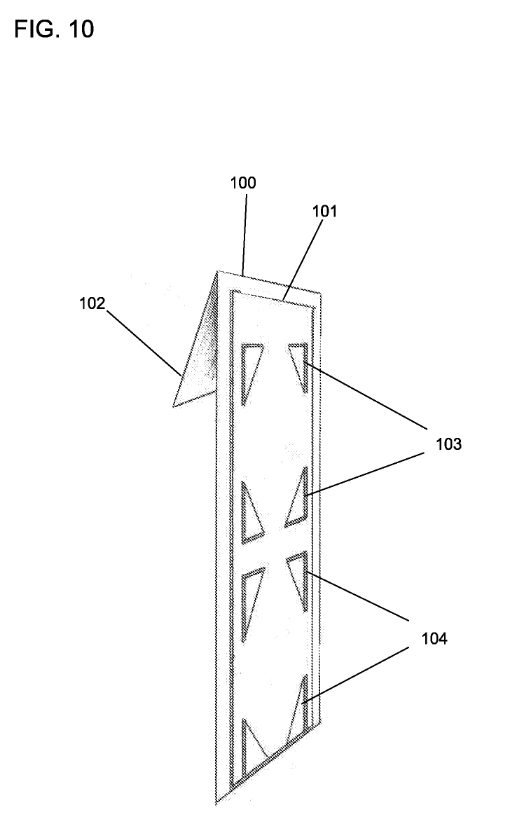

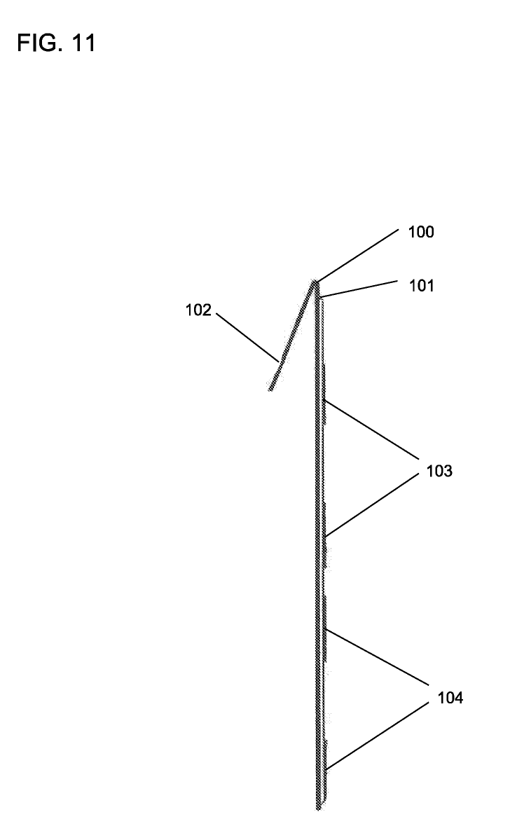

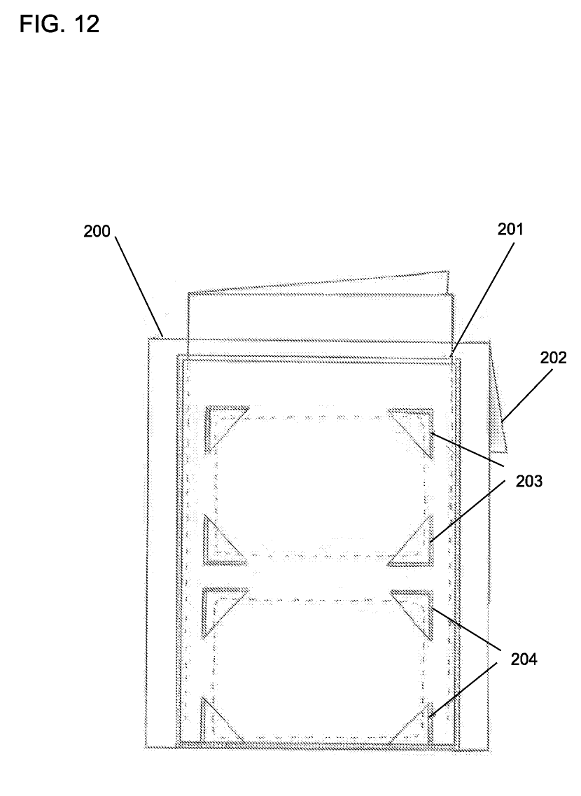

Referring to FIG. 9, FIG. 10. FIG. 11 and FIG. 12, this is a second embodiment of the vehicle window display. The VWD according to the second embodiment is essentially identical to the VWD according to the first embodiment, except that the front face is provided with small triangular transparent slots 203-204 that are capable of receiving and retaining the four corners of either a driver license, ID card, insurance card or gun permit or the like, as illustrated in FIG. 12.

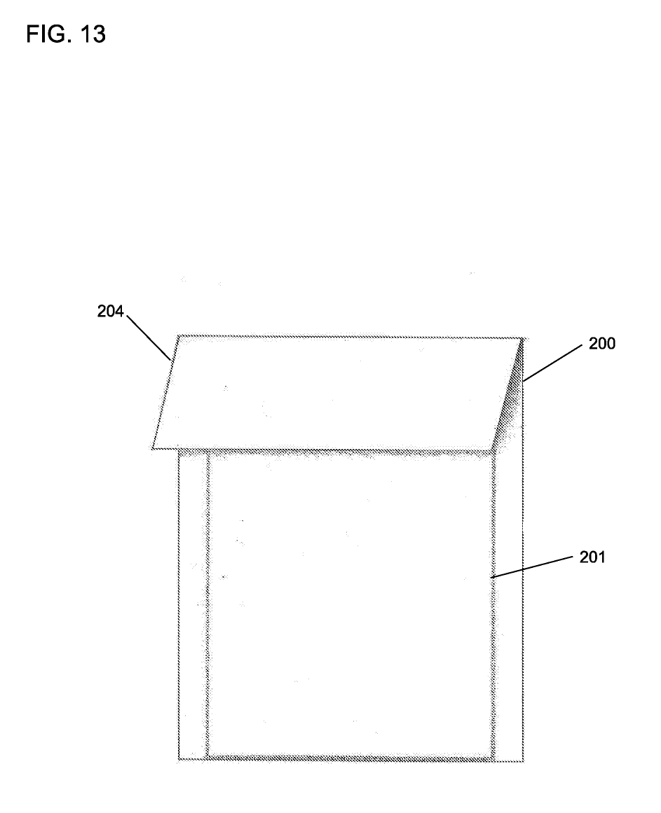

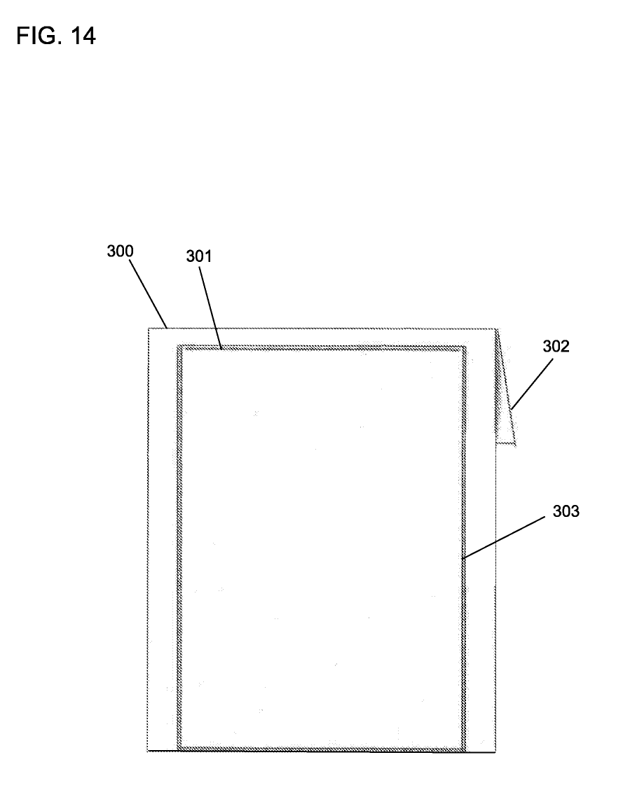

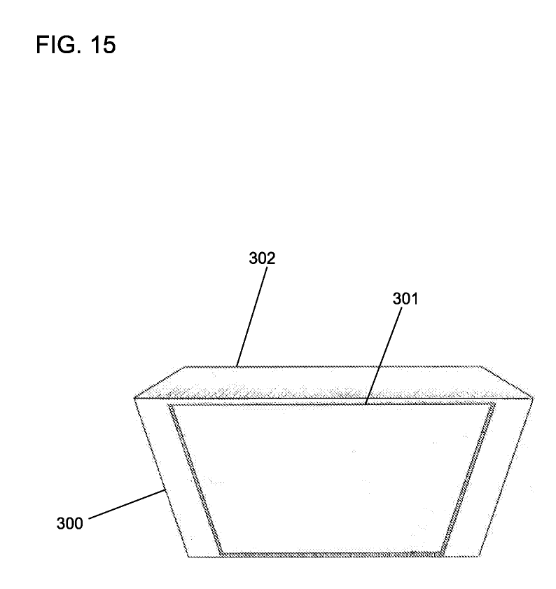

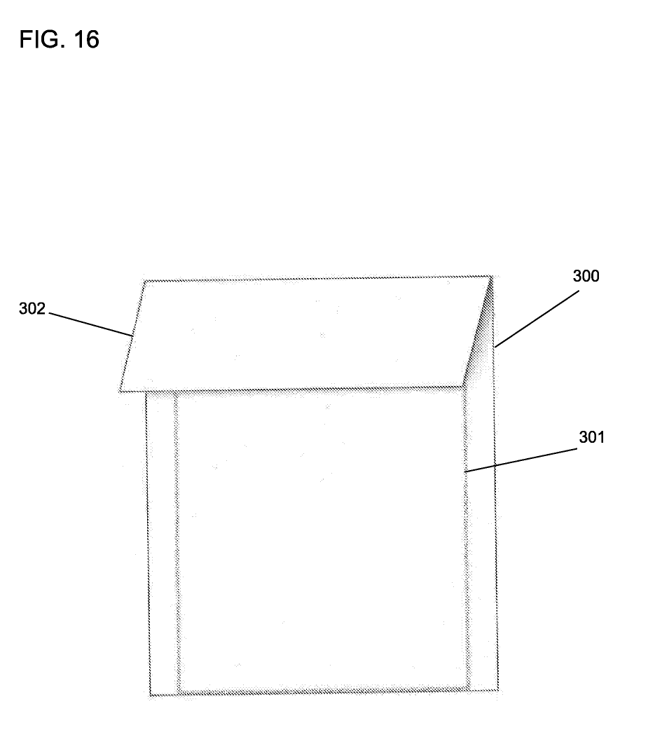

Referring to FIG. 13, FIG. 14. FIG. 15 and FIG. 16, this is a third embodiment of the VWD. The VWD according to the third embodiment is essentially identical to the VWD according to the first embodiment, except it does not contain the transparent rectangular pockets or triangular slots for receiving and retaining rectangular cards. In this third embodiment, the teachings of this application is not limited to the use by a motorist in traffic stops, but can be used to advertise or display items in a vehicle window, be it details about the make and model of the vehicle, a for sale sign or other form of advertisement.

The various aspects of what it described above can be used alone or in various combinations. It should be noted that the teaching of this application is not limited to mounting the VWD atop a partially open window glass pane, but it can be equally used by a motorist, such as one driving a semi trailer, motor home, ship, boat, motorcycle or the like, whom would simply hand the embodiment to a member of law enforcement when stopped or going through a checkpoint.

Although the teaching of the present application has been described in details for purpose of illustration, it is understood that such detail is solely for that purpose, and variations can be made therein by those skilled in the art without departing from the scope or teaching of this application. Those skilled in the art will readily envision many other possible variations are within its scope. For example, skilled artisans will readily be able to change the dimensions and shape of the various embodiments. They also will be able to make the device with more or less pockets or slots for retaining rectangular cards in front, side, top, center or of back of the frame or even without pockets or slots on the exterior or interior of the frame. Alternative embodiments can be made with reflective materials. Alternative embodiments can also be created without the rear flange, whereby a motorist or boater can simply hand the embodiment to a member of law enforcement or other official during a stop or routine checkpoint or registration. Skilled artisans will also be able to construct an embodiment that will receive and retain a vehicles registration and rectangular cards in the frame without the use of transparent slots or pockets. For example, an embodiment can be made out of plastic or other man made material that contains slots or pockets within the body of the frame.

Those skilled in the art will also be able to use alternative means to create a flange to affix to the window pane or use a magnet, adhesive, metal or plastic hook and or suction cup to attach the embodiment to a vehicles roof or door or other part therein. An alternative embodiment can also be created via suction cups, metal or plastic hook magnet or adhesive to the window. They will also be able to make the device out of alternative materials such as steel, aluminum, wood, leather, plastic or other material. Whilst endeavoring in the foregoing specification to draw attention to those features of the invention believed to be of particular importance it should be understood that the application claims protection in respect of any patentable feature or combination of features hereinbefore referred to and/or shown in the drawings whether or not particular emphasis has been placed therein. Therefore the present application is merely a preferred embodiment.

What is claimed is:

1. A vehicle windows display for displaying a vehicle registration, insurance card and driver license and any other documents, comprising:
a frame;
an inner pocket for vehicle registration;
a flange;
a pocket for identification; and,
a pocket for Insurance card or gun permit.

2. The material of the vehicle windows display of claim 1 is a very durable transparent plastic with colorful reflective tape around the edges, alternative materials such as steel, aluminum, wood, leather, plastic or other material can be used to make the vehicle windows display.

3. A method to use the vehicle windows display of claim 1 comprising:
a driver insert any rectangular cards, such as vehicle registration, insurance card, driver license and any other documents like gun permit in transparent rectangular pocket 1 and pocket 2 or triangular slots;
a driver install the vehicle windows display on the outside of a vehicle window glass pane; and,
an officer and easily check or remove the vehicle windows display when conducting a routine traffic stop.

4. The vehicle windows display of claim 1 where a driver can use when stopped by members of law enforcement during routine traffic stops, to simplify and deescalate the traffic stop process, and foster goodwill between members of law enforcement and motorist.

5. The vehicle windows display of claim 1 where motorist can feel safe by just placing their identification/registration on the window for the officer.

6. The vehicle windows display of claim 1 in the first embodiment where the frame consist of a flat transparent rectangular frame preferably made from a durable lightweight plastic or other man made material, the frame includes a back reversive rectangular shaped flange constructed to be easily affixed atop a partially open window glass pane for outside display.

7. The vehicle registration holder of the vehicle windows display of claim 1 is constructed by placing a smaller lightweight transparent flattened rectangular plastic atop the frame to create a pocket for receiving and retaining a vehicle registration.

8. The vehicle registration holder of claim 7 having a length and width with the length being larger than the width, the pockets of the vehicle registration holder is open along the width edges and closed along the length edges which a vehicle registration is inserted for easy display.

9. As recited in claim 1, the pocket 1 for identification and the pocket 2 for Insurance card or gun permit consist of transparent plastic or other man made material having a shaping element that has a width and length that are approximately identical to a width and length of the rectangular cards being held, nto which the cards are inserted for easy display.

10. As recited in claim 1 the rectangular card holders are attached to the front of the vehicle registration holder to form the pocket 1 for identification and pocket 2 for Insurance card or gun permit for receiving and retaining a plurality of plastic cards, where the pocket 1 for identification and pocket 2 for Insurance card or gun permit are open along the width edges and closed along the length edges.

11. A second embodiment of the vehicle window display of claim 1, where the front face is provided with small triangular transparent slots that are capable of receiving and retaining the four corners of either a driver license, ID card, insurance card or gun permit or the like.

12. A third embodiment of the vehicle window display of claim 1, where the teachings of this application is not limited to the use by a motorist in traffic stops, but can be used to advertise or display items in a vehicle window, be it details about the make and model of the vehicle, a for sale sign or other form of advertisement.

13. The various aspects of vehicle window display of claim 1 can be used alone or in various combinations, the vehicle window display is not limited to be used atop partially open window glass pane, but it can be equally used by a motorist, such as one driving a semi trailer, motor home, ship, boat, motorcycle or the like, whom would simply hand the embodiment to a member of law enforcement when stopped or going through a checkpoint.

14. The vehicle windows display of claim 1 can be made in various dimensions and shapes and can be made with more or less pockets or slots for retaining rectangular cards in front, side, top, center or of back of the frame or even without pockets or slots on the exterior or interior of the frame.

15. The vehicle windows display of claim 1 can be made with reflective materials and can also be created without the rear flange, whereby a motorist or boater can simply hand the embodiment to a member of law enforcement or other official during a stop or routine checkpoint or registration.

16. The vehicle windows display of claim 1 where a driver can receive and retain a vehicles registration and rectangular cards in the frame without the use of transparent slots or pockets.

17. The vehicle windows display of claim 1 where there are alternative means to create a flange to affix to the window pane or use a magnet, adhesive, metal or plastic hook and or suction cup to attach the embodiment to a vehicles roof or door or other part therein, an alternative embodiment can also be created via suction cups, metal or plastic hook magnet or adhesive to the window.
